(19) United States
(12) Patent Application Publication
(10) Pub. No.: US 2026/0236262 A1
(43) Pub. Date: Aug. 13, 2026

(54) BITMAP CONVERSIONS

(71) Applicant: Arm Limited, Cambridge (GB)

(72) Inventors: Joshua RANDALL, Austin, TX (US); Siying FENG, Austin, TX (US); Daniel ARULRAJ, Austin, TX (US)

(21) Appl. No.: 19/051,496

(22) Filed: Feb. 12, 2025

(51) Int. Cl. G06F 9/30

(52) U.S. Cl. CPC G06F 9/30145; G06F 9/30025

(57) ABSTRACT

Apparatuses, systems, methods, computer-readable media, and computer code are disclosed. An apparatus comprises processing circuitry and decoding circuitry to decode instructions and generate control signals for controlling the processing circuitry. In response to a bitmap-index conversion instruction indicating an input bitmap, the decoding circuitry generates control signals to control the processing circuitry to generate an index vector comprising a plurality of elements indicative of a plurality of indices of set bits in the input bitmap. In response to an index-bitmap conversion instruction indicating an index vector comprising a plurality of indices, the decoding circuitry generates control signals to control the processing circuitry to generate a plurality of partial bitmaps, each partial bitmap comprising a set bit corresponding to a respective one of the plurality of indices, and to combine the plurality of partial bitmaps to generate an output bitmap comprising set bits at each of the plurality of indices.

### TECHNICAL FIELD

The present disclosure relates to data processing. In particular, the present disclosure relates to converting between data formats.

### DESCRIPTION

In some data sets, known as sparse data sets, a significant number of values in the data set are made up of zeros. Sparse data sets have various uses, such as improving the efficiency of artificial intelligence (AI) through a process of neural network pruning, or in graph analysis using a breadth-first search algorithm. Several different data formats exist for encoding sparse data at varying levels of compression based on how much of the data is made up of zeros. For example, a bitmap may be used to identify the positions of non-zero values in the sparse data such that all other positions are assumed to be zero. While these data formats may be beneficial for reducing the memory capacity or bandwidth required to handle the sparse data sets, some data formats are less suitable for arithmetic operations that may be performed during data processing. On the other hand, converting the sparse data back into an uncompressed format reintroduces inefficiency due to unnecessarily performing repeated computations on zeros.

### SUMMARY

In one example embodiment described herein there is an apparatus comprising: processing circuitry; and decoding circuitry configured to decode instructions and generate control signals for controlling the processing circuitry, wherein in response to a bitmap-index conversion instruction indicating an input bitmap, the decoding circuitry is configured to generate control signals to control the processing circuitry to perform one or more iterations to generate an index vector comprising a plurality of elements indicative of a plurality of indices of set bits in the input bitmap.

In another example embodiment described herein there is provided an apparatus comprising processing circuitry; and decoding circuitry configured to decode instructions and generate control signals for controlling the processing circuitry, wherein in response to an index-bitmap conversion instruction indicating an index vector comprising a plurality of indices, the decoding circuitry is configured to generate control signals to control the processing circuitry to generate a plurality of partial bitmaps, each partial bitmap comprising a set bit corresponding to a respective one of the plurality of indices, and to combine the plurality of partial bitmaps to generate an output bitmap comprising set bits at each of the plurality of indices.

In another example embodiment described herein there is provided a system comprising: either or both apparatuses as described above implemented in at least one packaged chip; at least one system component; and a board, wherein the at least one packaged chip and the at least one system component are assembled on the board.

In another example embodiment described herein there is provided a chip-containing product comprising the system described above, wherein the system is assembled on a further board with at least one other product component.

In another example embodiment described herein there is provided a method comprising: decoding a bitmap-index conversion instruction indicating an input bitmap and generating control signals to control processing circuitry to perform one or more iterations to generate an index vector comprising a plurality of elements indicative of a plurality of indices of set bits in the input bitmap.

In another example embodiment described herein there is provided a non-transitory computer-readable medium storing computer-readable code for fabrication of an apparatus comprising: processing circuitry; and decoding circuitry configured to decode instructions and generate control signals for controlling the processing circuitry, wherein in response to a bitmap-index conversion instruction indicating an input bitmap, the decoding circuitry is configured to generate control signals to control the processing circuitry to perform one or more iterations to generate an index vector comprising a plurality of elements indicative of a plurality of indices of set bits in the input bitmap.

In another example embodiment described herein there is provided a computer program for controlling a host data processing apparatus to provide an instruction execution environment comprising: processing program logic; and decoding program logic configured to decode instructions and generate control signals for controlling the processing program logic, wherein in response to a bitmap-index conversion instruction indicating an input bitmap, the decoding program logic is configured to generate control signals to control the processing program logic to perform one or more iterations to generate an index vector comprising a plurality of elements indicative of one or more indices of set bits in the input bitmap.

### BRIEF DESCRIPTION OF THE DRAWINGS

The present invention will be described further, by way of example only, with reference to embodiments thereof as illustrated in the accompanying drawings, in which:

FIG. 1 illustrates a data processing apparatus comprising an instruction decoder and processing circuitry according to some example embodiments;

FIG. 2 illustrates index determination circuitry and preparation circuitry according to some example embodiments;

FIG. 3 illustrates a sequence of steps for converting a bitmap into an index vector according to some example embodiments;

FIG. 4 illustrates a worked example of the index determination circuitry and preparation circuitry operating in parallel;

FIGS. 5A to 5C illustrate different sequences of steps for decoding a bitmap-index conversion instruction according to some example embodiments;

FIG. 6 illustrates a worked example of combining a plurality of partial bitmaps according to some example embodiments;

FIG. 7 illustrates a sequence of steps for decoding an index-bitmap conversion instruction according to some example embodiments;

FIG. 8 illustrates a system and a chip-containing product according to some example embodiments;

FIG. 9 illustrates the use of a computer-readable medium for manufacturing an apparatus;

FIG. 10 illustrates a simulator implementation.

### DESCRIPTION OF EXAMPLE EMBODIMENTS

Before discussing the embodiments with reference to the accompanying figures, the following description of embodiments is provided.

As mentioned previously, a bitmap is one possible data format for compressing sparse data sets. The bitmap comprises a predefined number of bits, where any number of bits may be set (e.g. equal to 1) or unset (e.g. equal to 0) to convey information, such as the position of non-zero data items in a sparse data set. An index vector is another possible data format, which indicates the positions of non-zero data by storing one or more indices in a vector, for example an index vector element of 3 indicates that the third data value in the sparse data set is non-zero. Within a range of densities (i.e. proportion of non-zero data values) of a sparse data set, a bitmap provides more effective compression than an index vector. However, some efficient data processing algorithms are compatible with an index vector being used as an input, whereas a bitmap may not be compatible.

The present techniques provide a bitmap-index conversion instruction for efficient conversion from a bitmap format to an index vector format so that a programmer may make use of both the efficient compression of bitmaps and the efficient processing of index vectors. For each of the following examples, it will be appreciated that, while the bitmap-index conversion instruction is particularly useful in the processing of sparse data sets, the bitmap-index conversion instruction may be used generally for converting any bitmap into an index vector indicative of the set bits in the bitmap.

In at least some embodiments, an apparatus comprises processing circuitry and decoding circuitry configured to decode instructions and generate control signals for controlling the processing circuitry. A bitmap-index conversion instruction is provided which indicates an input bitmap, and in response to the bitmap-index conversion instruction, the decoding circuitry is configured to generate control signals to control the processing circuitry to generate an index vector comprising a plurality of elements indicative of a plurality of indices of set bits in the input bitmap. The processing circuitry performs one or more iterations to generate the index vector, hence a plurality of indices of the bitmap are capable of being identified using only one instruction. The bitmap-index conversion instruction therefore allows a programmer to obtain an index vector without deteriorating code density by repeatedly including an instruction for identifying each index of a set bit. Then the more efficient data processing algorithms as mentioned previously may be used to improve data processing in particular workloads.

In some examples, the processing circuitry comprises index determination circuitry and preparation circuitry, which are configured to carry out processes in parallel during one or more iterations. In a given iteration, the index determination circuitry is configured to determine an index of a set bit in the input bitmap and store the index in a corresponding element of the index vector. Independently of the index determination circuitry, the preparation circuitry is configured to generate an isolation of the set bit from the input bitmap. The isolation may then be used in a subsequent iteration for determination of a further index of the input bitmap by the index determination circuitry. For example, the isolation may be used to prevent the index determination circuitry from identifying the set bit in the subsequent iteration. The isolation may comprise a bitmap of equal size to the input bitmap, where the set bit is the only set bit and the remainder of the bitmap is zero.

The preparation circuitry is configured to generate the isolation of the set bit without having determined the index of that set bit. This therefore allows the index determination circuitry and the preparation circuitry to be configured to operate in parallel, thereby reducing the number of iterations required to convert between the input bitmap and the index vector and improving performance.

In some examples, in the given iteration, the index determination circuitry may determine the index by counting a number of leading zeros or a number of trailing zeros in the input bitmap. For example, if the input bitmap comprises the bits “0011”, then counting leading zeros would result in determining that a set bit has an index of 2 (assuming a zero-base index). In some examples, the input bitmap may be reversed, in which case the number of trailing zeros may be counted to arrive at the same index. To facilitate the determination in the subsequent iteration, the preparation circuitry may update the input bitmap, based on the isolation of the set bit, to remove the set bit from the input bitmap. Accordingly, in the subsequent iteration, the index determination circuitry may count the leading zeros or trailing zeros to determine the further index of another set bit in the input bitmap. To continue the above example, the set bit at index 2 is removed such that the input bitmap is updated to “0001”, where counting leading zeros in the subsequent iteration would result in determining that the further set bit has an index of 3. Accordingly, the resulting index vector comprises the indices 2 and 3. It will be appreciated that the updated input bitmap may be a working copy of the input bitmap, which is retained for the duration of the conversion operation. The original input bitmap may be kept in a register file without being updated to remove the set bits.

As mentioned above, the preparation circuitry is configured to generate the isolation of the set bit without any knowledge of where the set bit is in the bitmap, i.e. the isolation is generated independently of determining the index. In examples where the set bit is known to be a left-most or right-most set bit (due to the set bit being determined by counting leading zeros or trailing zeros as above), then a series of steps of logical bit manipulation can be used to arrive at the isolation of the set bit. In some examples, the preparation circuitry first obtains a reversed bitmap that is representative of the reverse of the input bitmap, e.g. a reversed bitmap of “0101” would be “1010”. The preparation circuitry then performs a bitwise AND operation between the reversed bitmap and a two's complement negation of the reversed bitmap to generate the isolation of the set bit. It will be understood that a two's complement negation is obtained by inverting all of the bits of a binary value and adding one to the result. To continue with the example reversed bitmap above, the isolation of the set bit may then be obtained as follows: “1010” & “0110”=“0010”. Hence, the isolation of the set bit at index 1 is generated (albeit reversed) without needing to count leading zeros or trailing zeros.

In some examples, the isolation of the set bit can be used to update the input bitmap as mentioned above. This may similarly be done using logical bit manipulation without knowledge of the index of the set bit. In particular, the preparation circuitry is configured to remove the set bit from the reversed bitmap by performing a bitwise XOR operation between the isolation of the set bit and the reversed bitmap. To continue the above example, “1010”∨“0010”=“1000”. Hence, the set bit has been removed from the reversed bitmap.

The point at which the input bitmap is reversed may vary in different examples. In some examples, the preparation circuitry is configured to generate the reversed bitmap as part of generating the isolation as described above. Accordingly, for the first iteration, the index determination circuitry will determine the index using the original (i.e. not reversed) input bitmap. Hence, the index may be determined by counting leading zeros for the first iteration. Since the update to remove the set bit is applied to the reversed bitmap, as described above, some examples may reverse the reverse bitmap again to arrive at the original bitmap with the set bit removed. However, this additional reversing step may be avoided by determining the indices by counting trailing zeros in iterations after the first iteration. Hence in such examples, in a case where the given iteration is a first iteration, the index determination circuitry is configured to determine the index by counting the number of leading zeros, and in a case where the given iteration is after the first iteration, the index determination circuitry is configured to determine the index by counting the number of trailing zeros.

In another example, the input bitmap may be reversed by the processing circuitry prior to the first iteration. Accordingly, index determination circuitry may be configured to determine the index by counting the number of trailing zeros regardless of whether the given iteration is the first iteration or not. In such examples, the index determination circuitry may be simplified because it is no longer required to be capable of counting leading zeros.

When determining an index by counting leading zeros or trailing zeros, a result may be that the index is out-of-range. For example, if the input bitmap comprises 8 bits, a set bit may be positioned between indices 0 and 7. If the index determination circuitry then counts 8 leading zeros, then an index is considered to be out-of-range. In other words, every bit in the input bitmap is zero. In some examples, the index determination circuitry is configured to generate a completion signal in response to determining that the index is out-of-range. The completion signal may then cause the processing circuitry not to perform any further iterations, because there are no set bits remaining.

Since the input bitmap may contain any number of set bits and the index determination circuitry is configured to determine one index in each iteration, it will be understood that the total number of iterations required to generate the index vector is data-dependent. In some examples, the processing circuitry comprises a variable latency unit comprising the index determination circuitry and the preparation circuitry, wherein the variable latency unit generates the index vector in a data-dependent number of iterations. A variable latency unit may be a processing unit which performs one or more data processing operations until a completion condition is met, e.g. the index vector is full or all indices of set bits have been determined. Such examples allow for improved throughput for generating the index vector because fewer cycles are required for, e.g. inserting operands at the beginning of each iteration. The use of a variable latency unit may introduce other complexities to the processing circuitry. For example, other data processing operations performed by other processing units may be affected by whether the variable latency unit has completed generating the index vector or not. For example, while the variable latency unit is generating the index vector, at least one other instruction may be stalled in a processing pipeline for the duration of the data-dependent number of iterations. Some processing units may also be permitted to continue performing other processing operations in parallel with the variable latency unit. In various examples, the variable latency unit may be synchronous or asynchronous with other components of the processing circuitry.

In other examples, the decoding circuitry may be responsive to the bitmap-index conversion instruction to generate control signals to control the processing circuitry to perform a predetermined number of iterations. In such examples, the predetermined number of iterations may be chosen such that the index vector is likely to be completed by the end of the predetermined number of iterations. While this may not achieve the same level of improved throughput as the variable latency unit, the throughput is still improved while avoiding the potential complexities of incorporating a variable latency unit into the processing circuitry. In some examples, in response to completing the predetermined number of iterations, it can be determined whether the input bitmap contains at least one index that has not yet been determined by the index determination circuitry. For example, such a determination may be based on whether the completion signal described above had been previously generated or not. If the input bitmap does contain at least one index that has not yet been determined by the index determination circuitry, the processing circuitry may repeat the predetermined number of iterations.

In some examples, after completing the predetermined number of iterations and determining that the input bitmap contains at least one index that has not yet been determined by the index determination circuitry, the processing circuitry may perform a bitwise shift operation on the input bitmap based on a most-recently determined index to generate a shifted bitmap. In this way, the indices that have already been determined are shifted out of the shifted bitmap. Then, when repeating the predetermined number of iterations, the index determination circuitry may continue to determine indices using the shifted bitmap.

In some examples, the index determination circuitry may further correct the determined indices when using the shifted bitmap in place of the input bitmap. In particular, the index determination circuitry may maintain the value of the most-recently determined index (i.e. the value by which the input bitmap was shifted to generated the shifted bitmap), and increments an index of the shifted bitmap by that value prior to storing the index in the corresponding element of the index vector.

In some examples, the number of elements available in the index vector is already known. For example, if a destination register to which the index vector is to be written is known to support up to 16 elements, then it is known that a maximum of 16 iterations may be performed before the index vector is full. The decoding circuitry may use this information such that the predetermined number of iterations is equal to a number of elements in the index vector. Accordingly, intermediate steps of checking whether the index vector is full will not be required.

In some examples, a processing pipeline may be configured such that the bitmap-index conversion instruction is to be executed in a fixed number of cycles, e.g. for timing purposes. The processing circuitry may be capable of determining a plurality of indices from the bitmap in one cycle, for example by performing a plurality of count-leading-zero operations. Accordingly, the decoding circuitry may use this information such that the predetermined number of iterations is equal to the number of count-leading-zero operations that the processing circuitry is capable of performing in one cycle. The decoding circuitry may then repeat the predetermined number of iterations as necessary for the fixed number of cycles.

Alternatively or in addition to the bitmap-index conversion instruction provided in the above embodiments, the present techniques further provide an index-bitmap conversion instruction for efficient conversion from the index vector format into a bitmap format. In the specific use case of performing data processing algorithms on a sparse data set described above, the index-bitmap conversion instruction may then be used to convert back into a bitmap to take advantage of the more effective compression, for example when writing the sparse data set back to memory.

In at least some embodiments, an apparatus comprises processing circuitry and decoding circuitry configured to decode instructions and generate control signals for controlling the processing circuitry, wherein in response to an index-bitmap conversion instruction indicating an index vector comprising a plurality of indices, the decoding circuitry is configured to generate control signals to control the processing circuitry to generate a plurality of partial bitmaps, each partial bitmap comprising a set bit corresponding to a respective one of the plurality of indices, and to combine the plurality of partial bitmaps to generate an output bitmap comprising set bits at each of the plurality of indices. The partial bitmaps comprise a number of bits, where the bit corresponding to a respective one of the plurality of indices is set. For example, where an index vector element specifies an index of 3, the resulting partial bitmap may be “0001”. Similar bitmaps are generated for each index specified by the index vector.

Since each partial bitmap is representative of a set bit at each index indicated by the index vector, parallel processing may be used to take each element of the index vector as an input operand to generate several of the partial bitmaps in parallel. In some examples, the partial bitmaps may also be combined in parallel.

In some examples, the processing circuitry is configured to combine the plurality of partial bitmaps in a bitwise OR operation. For example, where an index vector includes the indices: 2, 4, and 5 the processing circuitry will perform “001”|“00001”|“000001”=“001011”. Accordingly, the plurality of partial bitmaps may be combined in a single operation to generate the output bitmap.

As shown above, the partial bitmaps may be of any size. However, in some examples, it may be known that the output bitmap should have a specific number of bits. For example, if being used to represent a sparse data set, the number of bits could correspond to with the number of data values in the sparse data set. In another example, the number of bits may be defined by a size of a register identified in the instruction, e.g. as a destination register. It will be appreciated that the bitmap size refers to the size which could be generated by a single index-bitmap instruction. In some examples, the actual bitmap may be larger than can be accommodated in a single register. A programmer may decide to generate such bitmaps using multiple index-bitmap conversion instructions with intervening store instructions as appropriate to store intermediate results to a memory system. Therefore, in some examples, the index-bitmap conversion instruction indicates a bitmap size, and the processing circuitry generates an additional input bitmap having the bitmap size. Accordingly, when the input bitmap having the bitmap size is combined with each of the partial bitmaps, the output bitmap will also have the bitmap size. The input bitmap may comprise all zeros to only indicate the bitmap size, or may include one or more set bits from, e.g. a prior execution of the index-bitmap conversion instruction. This may occur if the index-bitmap conversion instruction is unable to convert the entire index vector into a bitmap. For example, if the instruction can convert a maximum of 4 indices at once, then an index vector comprising 8 indices will require the index-bitmap conversion instruction to be executed twice, with the output bitmap from the first execution is used as the input bitmap for the second execution.

At least some embodiments provide a method comprising decoding a bitmap-index conversion instruction indicating an input bitmap and generating control signals to control processing circuitry to perform one or more iterations to generate an index vector comprising a plurality of elements indicative of a plurality of indices of set bits in the input bitmap.

At least some embodiments provide a non-transitory computer-readable medium storing computer-readable code for fabrication of an apparatus comprising: processing circuitry; and decoding circuitry configured to decode instructions and generate control signals for controlling the processing circuitry, wherein in response to a bitmap-index conversion instruction indicating an input bitmap, the decoding circuitry is configured to generate control signals to control the processing circuitry to perform one or more iterations to generate an index vector comprising a plurality of elements indicative of a plurality of indices of set bits in the input bitmap.

At least some embodiments provide a computer program for controlling a host data processing apparatus to provide an instruction execution environment comprising: processing program logic; and decoding program logic configured to decode instructions and generate control signals for controlling the processing program logic, wherein in response to a bitmap-index conversion instruction indicating an input bitmap, the decoding program logic is configured to generate control signals to control the processing program logic to perform one or more iterations to generate an index vector comprising a plurality of elements indicative of a plurality of indices of set bits in the input bitmap.

At least some embodiments provide a method comprising: decoding an index-bitmap conversion instruction indicating an index vector comprising a plurality of indices and generating control signals to control processing circuitry to generate a plurality of partial bitmaps, each partial bitmap comprising a set bit corresponding to a respective one of the plurality of indices, and to combine the plurality of partial bitmaps to generate an output bitmap comprising set bits at each of the plurality of indices.

At least some embodiments provide a non-transitory computer-readable medium storing computer-readable code for fabrication of an apparatus comprising: processing circuitry; and decoding circuitry configured to decode instructions and generate control signals for controlling processing circuitry, wherein in response to an index-bitmap conversion instruction indicating an index vector comprising a plurality of indices, the decoding circuitry is configured to generate control signals to control the processing circuitry to generate a plurality of partial bitmaps, each partial bitmap comprising a set bit corresponding to a respective one of the plurality of indices, and to combine the plurality of partial bitmaps in parallel to generate an output bitmap comprising set bits at each of the plurality of indices.

At least some embodiments provide a computer program for controlling a host data processing apparatus to provide an instruction execution environment comprising: processing program logic; and decoding program logic configured to decode instructions and generate control signals for controlling the processing program logic, wherein in response to an index-bitmap conversion instruction indicating an index vector comprising a plurality of indices, the decoding program logic is configured to generate control signals to control the processing program logic to generate a plurality of partial bitmaps, each partial bitmap comprising a set bit corresponding to a respective one of the plurality of indices, and to combine the plurality of partial bitmaps in parallel to generate an output bitmap comprising set bits at each of the plurality of indices.

Particular embodiments will now be described with reference to the figures.

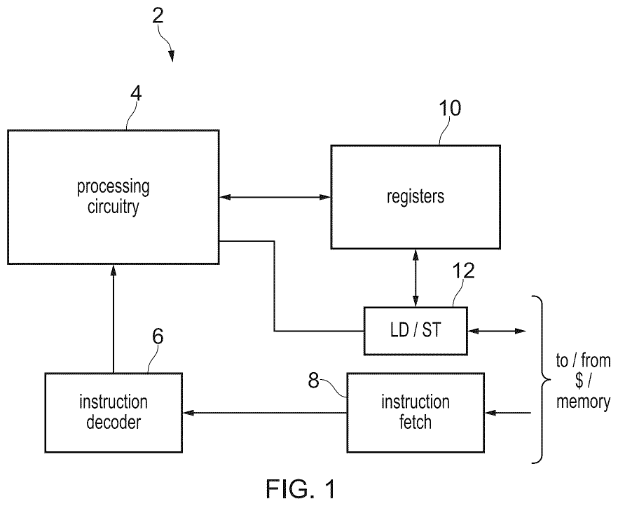

FIG. 1 schematically illustrates an example of a data processing apparatus 2 (for example a CPU or GPU) which comprises processing circuitry 4 for performing data processing operations in response to instructions decoded by an instruction decoder 6. The instructions decoded by the instruction decoder 6 are fetched from a cache or memory by instruction fetch circuitry 8.

Based on the decoded instructions, the instruction decoder 6 generates control signals to control the processing circuitry 4 to perform data processing operations represented by the instructions. Operands for the data processing operations are obtained from registers (selected as source registers) in a register file 10 comprising a certain number of registers. Results of the operations are written back to registers 10 (selected as destination registers) by the processing circuitry 4. For load/store instructions requesting that data from the cache or memory is loaded to the registers 10 or that data in the registers 10 is stored to the cache or memory, a load/store unit 12 may be instructed to carry out the load/store operation. It will be appreciated that FIG. 1 is a simplified example of a CPU or GPU 2 and that the CPU or GPU may include many other elements not shown in FIG. 1 for conciseness.

In accordance with the present techniques, the instruction decoder 6 is configured to support a bitmap-index conversion instruction, for example as part of an instruction set architecture (ISA). Based on a decoded bitmap-index conversion instruction, the instruction decoder 6 generates control signals to control the processing circuitry 4 to generate an index vector, where each data element in the index vector indicates an index of a set bit in an input bitmap. The input bitmap may be specified by the bitmap-index conversion instruction for example by reference to one of the registers 10, and may comprise any number of bits, of which any bit may be set (e.g. equal to 1) or unset (e.g. equal to 0). It will be appreciated that the input bitmap may be in the form of a scalar value or a vector. Hence, the input bitmap may be obtained from scalar or vector types of source register, either of which may be specified by the bitmap-index conversion instruction. One possible syntax of the bitmap-index conversion instruction could be “B2IDX <Zd><Zm>”, where B2IDX corresponds to a unique opcode of the bitmap-index conversion instruction, Zm identifies a vector register of the registers 10 that contains the input bitmap, and Zd identifies a vector register of the registers 10 to which the index vector is to be stored. Another possible syntax of the bitmap-index conversion instruction could be “B2IDX <Zd><Xm>”, where B2IDX and Zd are the same as above, and Xm identifies a scalar register of the registers 10 that contains the input bitmap. The bitmap-index conversion instruction may optionally specify an offset that is to be applied to each index that is generated or a data type of the output index vector.

In response to such an instruction, the instruction decoder 6, the processing circuitry 4 is controlled to perform one or more iterations to generate an index vector comprising a plurality of elements indicative of a plurality of indices of set bits in the input bitmap. For example, the processing circuitry 4 may retrieve the input bitmap from a source register of the registers 10, or in a case where the bitmap's size exceeds the capacity of a register, the processing circuitry 4 may retrieve a part of the input bitmap from a source register of the registers 10.

Each of the one or more iterations may correspond to micro-operations generated by the instruction decoder 6 and may be performed by one or more constituent execution units (e.g. arithmetic-logic unit, floating point unit, branch unit, etc) that are contained in the processing circuitry 4. The processing circuitry 4 may also comprise a plurality of vector processing lanes in order to perform several iterations in parallel, where each lane is capable of identifying one of the plurality of indices to be included in the generated index vector. After identifying each of the plurality of indices and generating the index vector, the processing circuitry 4 may write the index vector to a destination register in the registers 10.

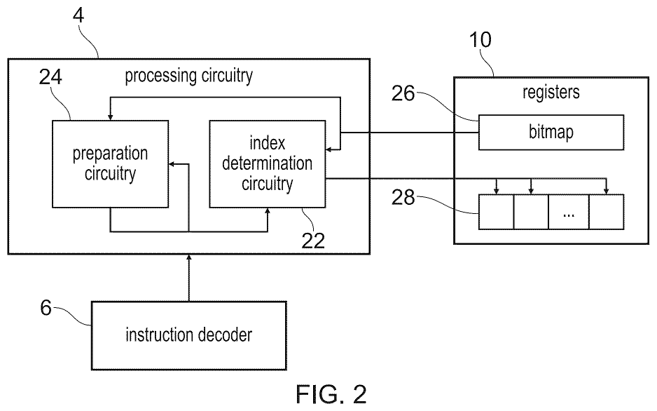

FIG. 2 schematically illustrates an example of the processing circuitry 4 configured to perform the data processing operations represented by one example implementation of the bitmap-index conversion instruction to generate the index vector. The processing circuitry 4 in this example comprises index determination circuitry 22 and preparation circuitry 24, which receive an input bitmap 26 from the registers 10. Under the control of the instruction decoder 6, the processing circuitry 4 is configured to perform the one or more iterations as above. In one such iteration, the index determination circuitry 22 determines an index of a set bit in the input bitmap 26. In some examples, such a determination may be performed by counting leading zeros to identify the index of a left-most set bit, or counting trailing zeros to identify the index of a right-most set bit. When an index has been determined, the index determination circuitry 22 stores the index in an element of the index vector 28 in the registers 10. For example, the determined index is stored in the first data element of the index vector 28 in a first iteration, in the second data element of the index vector 28 in a second iteration, and so on. Accordingly, by performing one or more iterations to determine the indices, the index vector 28 is gradually generated.

In parallel with the operations of the index determination circuitry 22, the preparation circuitry 24 is configured to prepare a bitmap for a subsequent iteration for determination of a further index. In particular, the preparation circuitry 24 generates an isolation of the set bit (i.e. the bit of which the index is being determined by the index determination circuitry), which may be used to in subsequent iterations to identify that the index of that set bit has already been determined. In some examples, the isolation of the set bit can be used to update the input bitmap 26 to remove the set bit, so that a count-leading-zeros operation in the subsequent iteration will identify the index of the next set bit in the input bitmap 26. As shown in FIG. 2, the information generated by the preparation circuitry 24 can then be sent to the index determination circuitry 22 for use in the subsequent iteration. Additionally, the output of the preparation circuitry 24 is looped back into the preparation circuitry 24 so that an isolation of the further set bit can be generated in the subsequent iteration. This iterative process can repeat as many times as necessary until the index vector 28 is full, or until the index of every set bit has been determined.

As mentioned above, the index determination circuitry 22 and the preparation circuitry 24 are configured to operate in parallel. Accordingly, the generation of the isolation by the preparation circuitry 24 is independent of any determination made by the index determination circuitry 22. In other words, the preparation circuitry 24 does not use the result of the index determination circuitry 22 as part of generating the isolation of the set bit. In this way, the parallel processes are capable of performing the conversion from the input bitmap 26 to the index vector 28 in fewer cycles, hence improving performance.

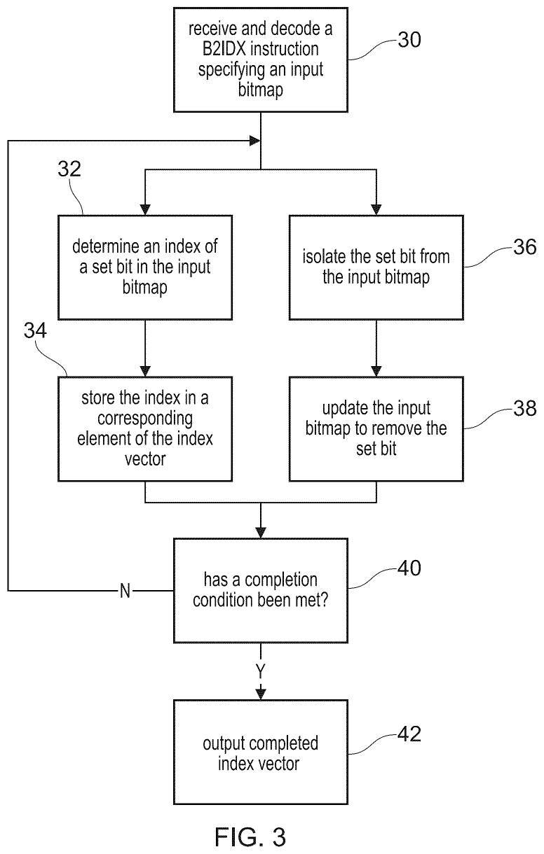

FIG. 3 illustrates a series of steps for converting the input bitmap 26 to the index vector 28 according to the above example implementation. In step 30, a bitmap-index conversion instruction is received and decoded by the instruction decoder 6. At step 32, an index of a set bit in the input bitmap is determined by the index determination circuitry 22, and at step 34, the index is stored in a corresponding element of the index vector 28. In parallel to steps 32 and 34, the set bit is isolated from the input bitmap in step 36 by the preparation circuitry 24, and the input bitmap is updated to remove the set bit in step 38. At step 40, it is determined whether every index has been determined and/or if the index vector is full. Either of these conditions may be used to indicate that the conversion has been completed. Hence, if the condition is not met, i.e. N at step 40, then the process loops back to perform the parallel steps 32 to 38 again. If the condition is met, i.e. Y at step 40, then the index vector 28 is output at step 42.

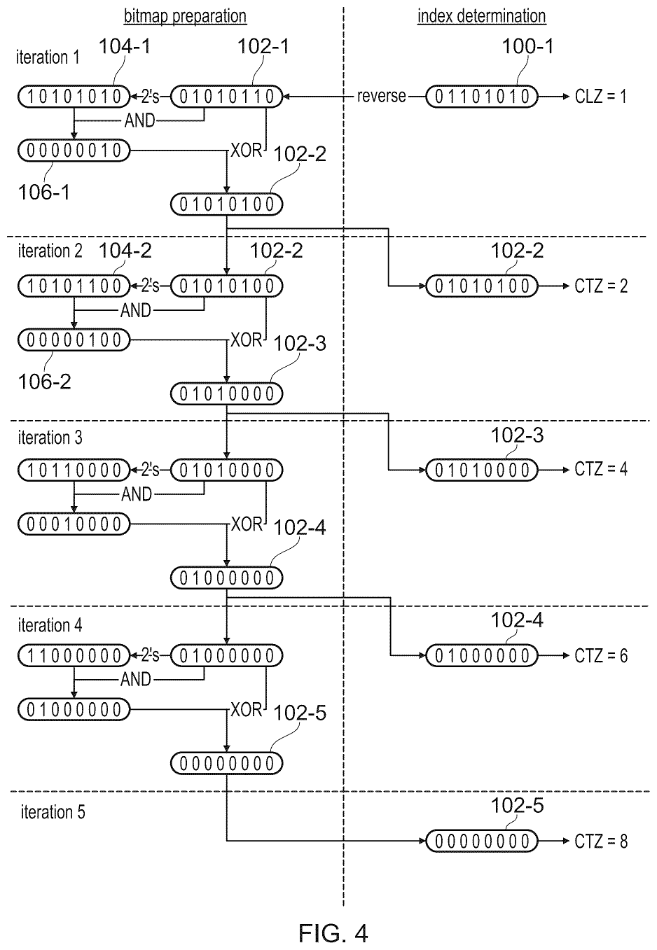

As described above, the preparation circuitry 24 is configured to isolate the set bit without any knowledge of the set bit's index. This can be achieved using an algorithm of bit manipulations that will remove the left-most set bit or the right-most set bit in each iteration. FIG. 4 illustrates a worked example of one such algorithm. In this example, an 8-bit input bitmap 100-1 is provided comprising the bits “01101010”, but it will be appreciated that the input bitmap 100-1 may be of any size, and may contain any combination of set bits and unset bits. To a human reader, it is clear that the input bitmap 100-1 has 4 set bits at the indices: 1, 2, 4 and 6 (assuming a zero-base index). The following worked example illustrates how these indices may be determined in a number of iterations according to the example implementation described in FIG. 2.

In iteration 1, the index determination circuitry 22 performs a count-leading-zeros (CLZ) operation on the input bitmap 100-1, which produces the result of 1. Hence, the first determined index is 1, which can be stored in the first element of the index vector. In parallel, the preparation circuitry 24 performs the following process. The bitmap is reversed to produce a reversed bitmap 102-1. Then, a two's complement negation 104-1 of the reversed bitmap 102-1 is computed, and a bitwise AND is performed between the reversed bitmap 102-1 and the two's complement negation 104-1 to generate the isolation 106-1 of the set bit. Note that, due to the reversal, the set bit is now has an index of 6. Using the isolation 106-1 of the set bit, the set bit can be removed from the reversed bitmap 102-1 by performing a bitwise XOR to generate an updated bitmap 102-2. In this way, the set bit has been removed without any need to determine what its index is. Accordingly, this allows the index determination and bitmap preparation to be parallelised for improved performance.

In iteration 2, the index determination circuitry 22 may reverse the updated bitmap 102-2 again to perform another CLZ operation for determining the next index. This additional reversal can be skipped by instead performing a count-trailing-zeros (CTZ) operation on the updated bitmap 102-2, which produces a result of 2. Hence, the second determined index is 2, which can be stored in the second element of the index vector. In parallel, the preparation circuitry 24 performs the same process as in the first iteration based on the updated bitmap 102-2, i.e. computing the two's complement negation 104-2, performing a bitwise AND to generate the isolation 106-2 of the second set bit, and performing a bitwise XOR to generate an updated bitmap 102-3 with the second set bit removed.

In iteration 3, the index determination circuitry 22 performs another CTZ operation using the updated bitmap 102-3, which produces a result of 4. Hence, the third determined index is 4, which can be stored in the third element of the index vector. In parallel, the preparation circuitry 24 performs the same process as in the previous iterations to generate an updated bitmap 102-4 with third set bit removed. In iteration 4, the index determination circuitry 22 performs another CTZ operation using the updated bitmap 102-4, which produces a result of 6. Hence, the fourth determined index is 6, which can be stored in the fourth element of the index vector. In parallel, the preparation circuitry 24 performs the same process as in the previous iterations to generate an updated bitmap 102-5 with the fourth set bit removed.

Since the input bitmap 100-1 only contained 4 set bits in this example, the updated bitmap 102-5 contains no set bits. Accordingly, in iteration 5, the index determination circuitry 22 performs another CTZ using the updated bitmap 102-5, which produces a result of 8. The index determination circuitry 22 can identify that this index is out-of-range of the original input bitmap 100-1, because an 8-bit bitmap can only contain bits at indices between 0 and 7. The index determination circuitry 22 therefore generates a completion signal to indicate that the index of every set bit has been determined and stored in the index vector. The processing circuitry 4 then outputs the completed index vector comprising data elements indicating the indices of 1, 2, 4 and 6.

It will be appreciated that FIG. 4 illustrates just one example of an algorithm that can isolate the set bit from the input bitmap without needing to determine the index, and other algorithms may also work. In some examples, the input bitmap 110-1 may be reversed prior to iteration 1 and the index determination circuitry 22 determines the first index using an CTZ operation instead of a CLZ operation. In this way, the index determination circuitry 22 may be simplified by not requiring the capability to perform both a CLZ operation and an CTZ operation. In other examples, multiple different algorithms may be supported and specified using different ISA instructions or by additional control data included in the bitmap-index conversion instruction. For example, the two possible algorithms described above (where the reversal occurs at different points) may both be supported in a single implementation of the processing circuitry. For example, a multiplexer may be implemented to select the original or reversed input bitmap as required for the particular step of the algorithm to switch between performing a CLZ operation or a CTZ operation.

As will be appreciated from the above worked example, the number of iterations that are required to determine every index of the bitmap is data-dependent, i.e. depending on how many set bits there are. In general, for the algorithm shown in FIG. 4, to convert a bitmap comprising N set bits, the processing circuitry may need to perform N+1 iterations (identifying each index in the first N iterations, and then generating the completion signal in the last iteration). Hence, the instruction decoder 6 may not be able to determine how many iterations will be required when generating the control signals in response to the bitmap-index conversion instruction. In various examples, the instruction decoder 6 may therefore generate control signals in response to the bitmap-index conversion instruction in several different ways.

In one such example, the processing circuitry 4 comprises a variable latency unit, where the variable latency unit comprises the index determination circuitry 22 and the preparation circuitry 24. The variable latency unit is a processing unit that is capable of performing the iterations until a completion condition has been met without direct control of the instruction decoder 6 between iterations. The inclusion of a variable latency unit may improve throughput, but may also increase complexity of the processing pipeline as a whole. For example, one or more instructions may need to be stalled before being issued to the instruction decoder 6. However, other processing units, e.g. an arithmetic logic unit or the load/store unit 12 may continue to perform data processing operations while the variable latency unit is generating the index vector.

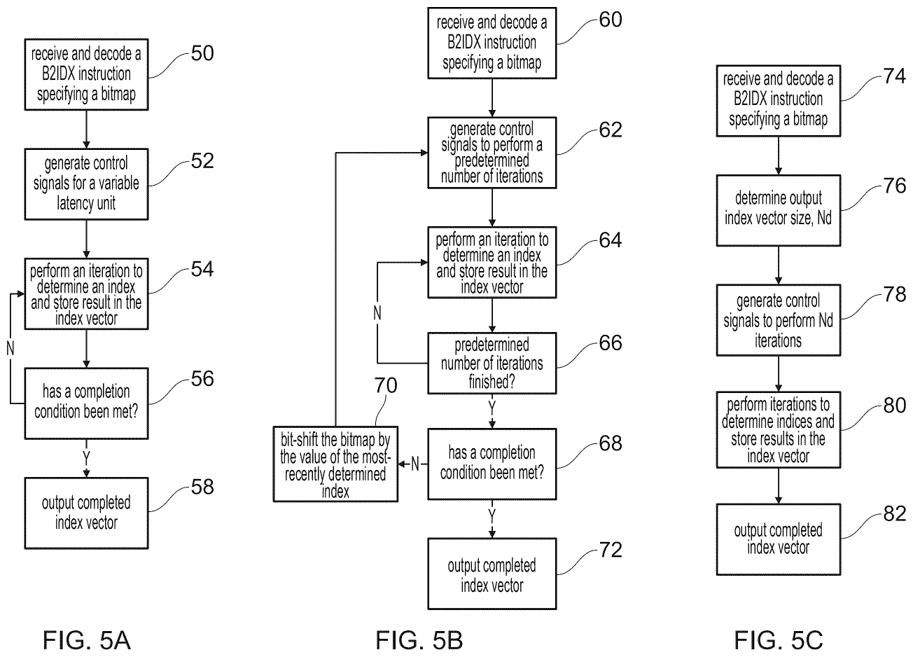

FIG. 5A illustrates a sequence of steps that may be performed in the above example. At step 50, a bitmap-index conversion instruction is received and decoded by the instruction decoder 6. At step 52, the instruction decoder 6 generates control signals for controlling the variable latency unit. At step 54, the variable latency unit performs an iteration to determine an index of a set bit and store the result in the index vector. Additionally, as in previous examples, the iteration will also generate the isolation of the set bit for use in a subsequent iteration. In step 56, the variable latency unit determines whether a completion condition has been met. For example, the variable latency unit monitors for a completion signal having been output to indicate that every index has been determined (as in iteration 5 of FIG. 4) or whether the index vector is full. If the completion condition is not met, then another iteration is perform at step 54. Once the completion condition is met, the completed index vector is output at step 58. By generating control signals for a variable latency unit in this way, the instruction decoder 6 does not need to determine how many iterations are required. However, some additional complexity may be required for other aspects of the processing pipeline to continue operating while the variable latency unit is generating the index vector.

In other examples, the instruction decoder 6 may be configured to generate control signals to cause the processing circuitry 4 to perform a predetermined number of iterations. The predetermined number may be fixed or may vary depending on the particular data in question. In some examples, the predetermined number may be arbitrary, and then an addition step of determining whether further iterations are required may be included after the predetermined number of iterations. If so, then the predetermined number of iterations may be repeated. Repeating the predetermined number of iterations may take the form of a branch micro-operation to cause the bitmap-index conversion instruction to branch to itself.

When repeating the number of iterations, the most-recent updated bitmap, i.e. with the set bits that have already been determined by the index determination circuitry 22 being removed, may be used as the input bitmap. Alternatively, in examples where an updated bitmap cannot be retained for a repetition of the iterations, the processing circuitry 4 may perform a bitwise shift operation on the input bitmap based on a most-recently determined index to generate a shifted bitmap such that the set bits that have already been determined are shifted out of the bitmap. The processing circuitry may then repeat the predetermined number of iterations using the shifted bitmap in place of the input bitmap. Since any determined indices will be offset by the bit-shifted amount, the repeated predetermined number of iterations may require that an index determined by the index determination circuitry 22 is incremented by the value of the most-recently determined index (i.e. to cancel out the change in index due to the bitwise shift operation).

FIG. 5B illustrates a sequence of steps that may be performed in examples in which the predetermined number of iterations may be arbitrary. At step 60, a bitmap-index conversion instruction is received and decoded by the instruction decoder 6. At step 62, the instruction decoder 6 generates controls signals for controlling the processing circuitry 4 to perform a predetermined number of iterations. In step 64, the processing circuitry 4 performs an iteration to determine an index of a set bit and store the result in the index vector. Additionally, as in previous examples, the iteration will also generate the isolation of the set bit for use in a subsequent iteration. In step 66, it is determined whether the predetermined number of iterations have been completed. If not, then another iteration is performed at step 64. If so, then in step 68, the processing circuitry 4 determines whether a completion condition has been met. As in previous examples, the completion condition may be based on whether every index has been determined and/or if the index vector is full. If the completion condition is not met, then the predetermined number of iterations are to be repeated. Optionally, as mentioned above, the bitmap may be bit-shifted by the value of the most-recently determined index at step 70 prior to generating controls signals to repeat the predetermined number of iterations at step 62. If the completion condition is met, then the completed index vector is output at step 72.

In other examples, the predetermined number may be based on a limitation of the processing circuitry 4, such as the number of CLZ or CTZ operations that the processing circuitry 4 is capable of performing in one cycle. For example, if the processing circuitry 4, or more particularly the index determination circuitry 22, is capable of performing up to 8 CLZ or CTZ operations in one cycle, then the instruction decoder 6 generates control signals to control the processing circuitry 4 to perform 8 iterations. If multiple cycles are required to complete the index vector, then the predetermined number of iterations may be repeated as described above. In examples where the processing circuitry 4 is arranged into pipeline stages, a limitation of the processing circuitry 4 may instead be a number of iterations that could be performed in an execution time-step, which is equivalent to the number of cycles for an operation to pass through every pipeline stage. For example, the CLZ/CTZ operation may be performed by one pipeline stage, while the bitmap preparation is being performed by another pipeline stage, thereby allowing multiple iterations to be performed within one execution time-step.

In other examples, the predetermined number may be based on an operand size specified by the bitmap-index conversion instruction. For example, if a specified destination register for the index vector in the register file 10 is capable of holding 16 data elements, then it can be known that a maximum of 16 iterations may be performed before the index vector is full. Hence, the instruction decoder 6 may generate control signals to cause the processing circuitry 4 to perform 16 iterations, or more generally, to cause the processing circuitry to perform a number of elements equal to the number of elements in the index vector.

FIG. 5C illustrates a sequence of steps that may be performed in examples in which the predetermined number of iterations may be based on the index vector size. At step 74, a bitmap-index conversion instruction is received and decoded by the instruction decoder 6. At step 76, the output index vector size, Nd, is determined. As above, Nd may be a characteristic of a destination register specified by the bitmap-index conversion instruction. At step 78, the instruction decoder 6 generates controls signals for controlling the processing circuitry 4 to perform Nd iterations. In step 80, the processing circuitry performs the iterations to determine the indices of Nd set bits and stores the results in the index vector. Additionally, as in previous examples, each iteration will also generate the isolation of the set bit for use in each subsequent iteration. At step 82, the completed index vector is output. Accordingly, the process of FIG. 5C advantageously does not require an intermediate step to determine whether a completion condition has been met (as shown in FIGS. 5A and 5B). Nonetheless, a completion signal may still be generated by the index determination circuitry 22, e.g. in response to determining that an index is out-of-range. In response to the completion signal, the processing circuitry 4 may exit the Nd iterations early or suppress any remaining iterations, since the input bitmap is now known to contain fewer than Nd set bits.

The apparatus according to the above embodiments is therefore capable of efficiently converting an input bitmap into an index vector. A further instruction may be provided for converting from an index vector to a bitmap. In particular, returning to FIG. 1, the instruction decoder 6 can be (additionally or alternatively) configured to support an index-bitmap conversion instruction, which may be part of the same ISA. Based on a decoded index-bitmap conversion instruction, the instruction decoder 6 generates control signals to control the processing circuitry 4 to generate an output bitmap comprising set bits at each index specified by data elements in an index vector. The index vector may be specified by the index-bitmap conversion instruction for example by reference to one of the registers 10. The index vector may comprise any number of data elements. It will be appreciated that the output bitmap may be in the form of a scalar value or a vector. Hence, the output bitmap may be written to scalar or vector types of source register, either of which may be specified by the index-bitmap conversion instruction. One possible syntax of the index-bitmap conversion instruction could be “IDX2B <Zd><Zn><Pg>”, where IDX2B corresponds to a unique opcode of the index-bitmap conversion instruction, Zn identifies a vector register of the registers 10 that contains the index vector, Zd identifies a vector register of the registers 10 to which the output bitmap is to be stored, and Pg identifies a predicate register indicating one or more active elements in the register Zn. Another possible syntax of the index-bitmap conversion instruction could be “IDX2B <Xd><Zn><Pg>”, where IDX2B, Zn and Pg are the same as above, and Xd identifies a scalar register of the registers 10 to which the output bitmap is to be stored.

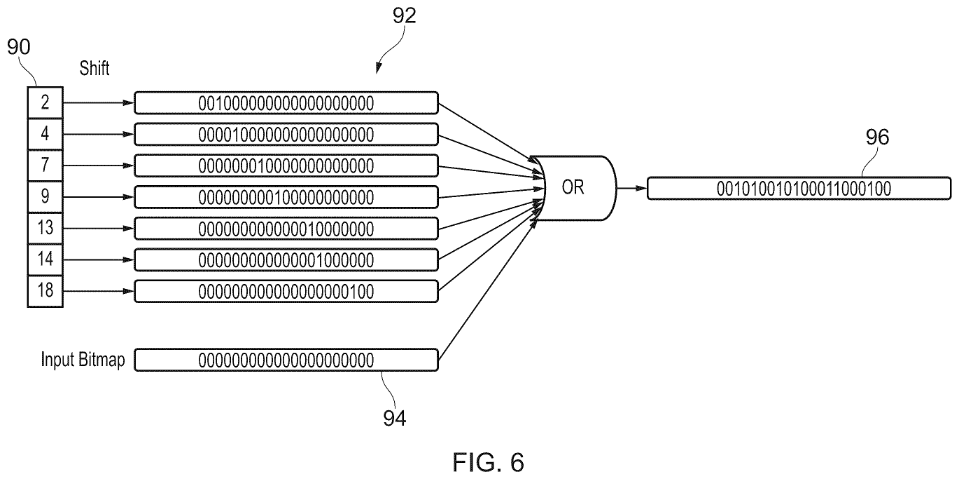

Under the control of the instruction decoder 6, the processing circuitry 4 is configured to generate a plurality of partial bitmaps, where each partial bitmap comprises one set bit corresponding to a respective one of the plurality of indices identified in the index vector. FIG. 6 illustrates a worked example of the operations performed by the processing circuitry 4 in such examples. The input vector 90 comprises the indices: 2, 4, 7, 9, 13, 14 and 18 (assuming a zero-base index). Hence, the processing circuitry generates 7 partial bitmaps 92. As shown, the first partial bitmap has a set bit at index 2, the second partial bitmap has a set bit at index 4, and so on. The partial bitmaps 92 are then combined in a bitwise OR operation to generate the output bitmap 96. An indication of the output bitmap size may be obtained in a variety of ways. In some examples, an input bitmap 94 may be provided, e.g. from the register Zd or Xd, which defines the output bitmap size. In other examples, an additional scalar value may be specified by the index-bitmap instruction, e.g. as an immediate value or a further source register. The scalar value may identify a bitmap size directly, or may identify that the bitmap size is a given multiple of the size of the destination register. In still other examples, where the index-bitmap instruction is to be performed by vector processing circuitry comprising a plurality of lanes, the bitmap size may be defined by the number of lanes which are controlled to be active, e.g. as defined in a predicate value.

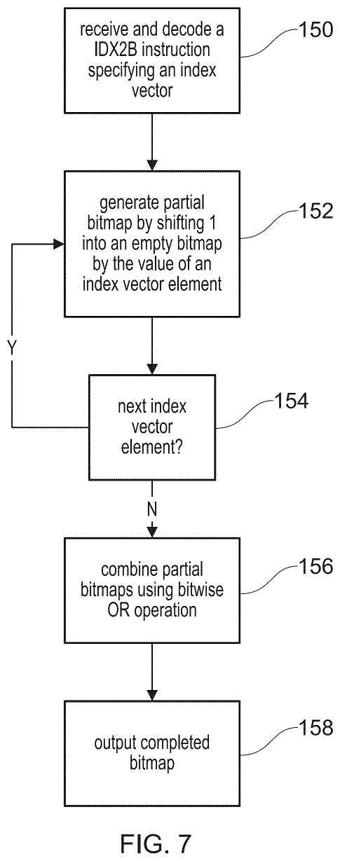

FIG. 7 illustrates a sequence of steps to be performed by the apparatus in response to an index-bitmap conversion instruction. At step 150, an index-bitmap conversion instruction is received and decoded by the instruction decoder 6. At step 152, the processing circuitry 4 generates a partial bitmap by performing a bitwise shift of a set bit by the value of an index vector element. At step 154, it is determined whether there are any further indices indicated by the index vector. If so, then step 152 is repeated to generate another partial bitmap for the next index. It will be appreciated that, in implementations that are capable of parallel processing, step 152 may be performed in respect of a plurality of index vector elements in parallel. Once all of the partial bitmaps have been generated, the partial bitmaps are combined using a bitwise OR operation at step 156 to generate the output bitmap. The completed bitmap is then output at step 158.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

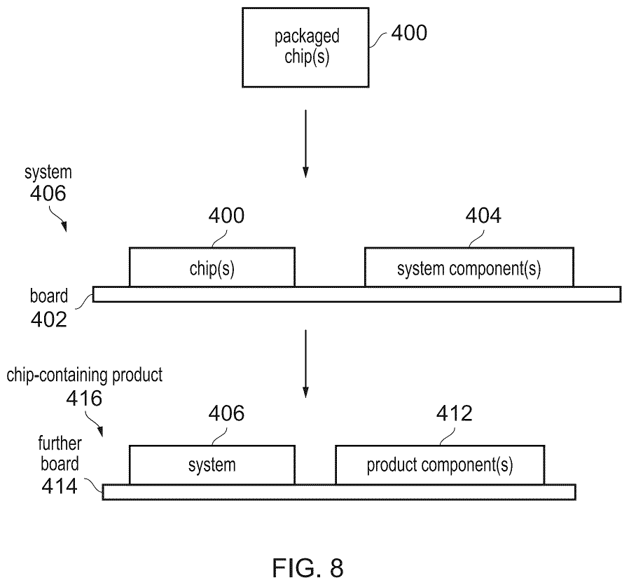

As shown in FIG. 8, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc. ; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

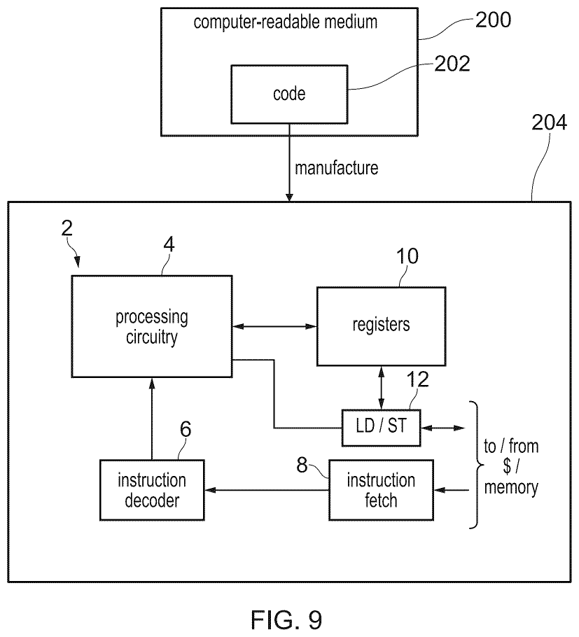

FIG. 9 illustrates an example of concepts described herein embodied in computer-readable code 202 for fabrication of an apparatus 204 that embodies the described concepts. For example, the computer-readable code 202 can be used at one or more stages of a semiconductor design and fabrication process, including an electronic design automation (EDA) stage, to fabricate an integrated circuit comprising the apparatus 204 embodying the concepts. The above computer-readable code may additionally or alternatively enable the definition, modelling, simulation, verification and/or testing of an apparatus 204 embodying the concepts described herein.

For example, the computer-readable code 202 for fabrication of an apparatus 204 embodying the concepts described herein can be embodied in code defining a hardware description language (HDL) representation of the concepts. For example, the code 202 may define a register-transfer-level (RTL) abstraction of one or more logic circuits for defining an apparatus 204 embodying the concepts. The code 202 may define a HDL representation of the one or more logic circuits embodying the apparatus 204 in Verilog, SystemVerilog, Chisel, or VHDL (Very High-Speed Integrated Circuit Hardware Description Language) as well as intermediate representations such as FIRRTL. Computer-readable code 202 may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code 202 may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code 202 a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code 202 may comprise a mix of code representations for fabrication of an apparatus 204 (or indeed just any component of the apparatus 204), for example including a mix of one or more of an RTL representation, a netlist representation, or another computer-readable definition to be used in a semiconductor design and fabrication process to fabricate an apparatus 204 embodying the invention. Alternatively or additionally, the concept may be defined in a combination of a computer-readable definition to be used in a semiconductor design and fabrication process to fabricate an apparatus 204 and computer-readable code 202 defining instructions which are to be executed by the defined apparatus once fabricated.

Such computer-readable code can be disposed in any known transitory computer-readable medium 200 (such as wired or wireless transmission of code over a network) or non-transitory computer-readable medium 200 such as semiconductor, magnetic disk, or optical disc. An integrated circuit fabricated using the computer-readable code 202 may comprise components such as one or more of a central processing unit, graphics processing unit, neural processing unit, digital signal processor or other components that individually or collectively embody the concept.

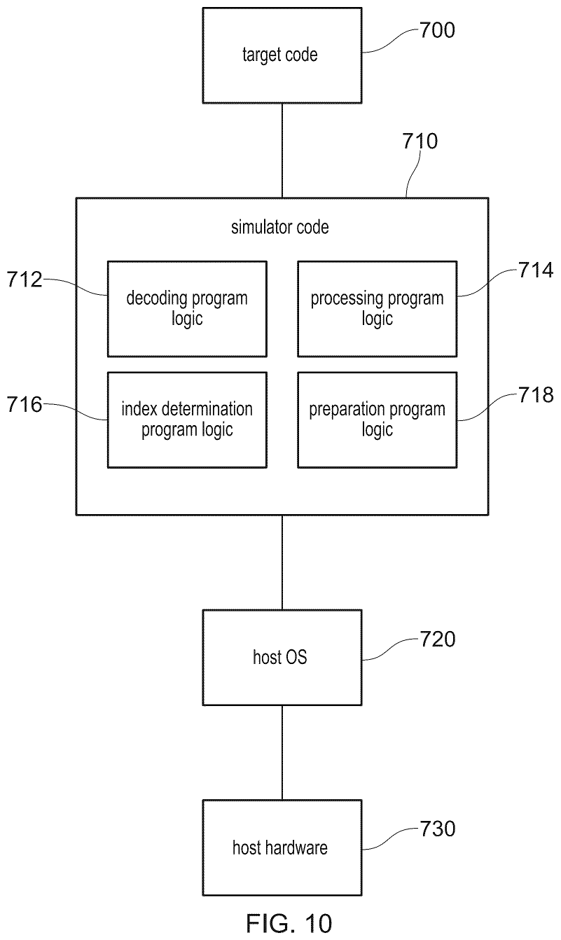

FIG. 10 illustrates a simulator implementation that may be used. Whilst the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 730, optionally running a host operating system 720, supporting the simulator program 710. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on the host hardware (for example, host processor 730), some simulated embodiments may make use of the host hardware, where suitable.

The simulator program 710 may be stored on a computer-readable storage medium (which may be a non-transitory medium), and provides a program interface (instruction execution environment) to the target code 700 (which may include applications, operating systems and a hypervisor) which is the same as the interface of the hardware architecture being modelled by the simulator program 710. Thus, the program instructions of the target code 700 may be executed from within the instruction execution environment using the simulator program 710, so that a host computer 730 which does not actually have the hardware features of the apparatus 2 discussed above can emulate these features. In particular, the host computer 730 can emulate the apparatus 2 by using the decoding program logic 712, processing program logic 714, index determination program logic 716 and preparation program logic 718 contained within the simulator code 710.

Some examples of the present invention are set out in the following clauses:
(1) An apparatus comprising:
   processing circuitry; and
   decoding circuitry configured to decode instructions and generate control signals for controlling the processing circuitry, wherein
   in response to a bitmap-index conversion instruction indicating an input bitmap, the decoding circuitry is configured to generate control signals to control the processing circuitry to perform one or more iterations to generate an index vector comprising a plurality of elements indicative of a plurality of indices of set bits in the input bitmap.
(2) The apparatus of clause (1), wherein:
   the processing circuitry comprises index determination circuitry and preparation circuitry, wherein in a given iteration:
      the index determination circuitry is configured to determine an index of a set bit in the input bitmap and store the index in a corresponding element of the index vector; and
      the preparation circuitry is configured to generate an isolation of the set bit from the input bitmap, wherein the isolation is to be used in a subsequent iteration for determination of a further index of the input bitmap by the index determination circuitry,
   wherein the index determination circuitry and the preparation circuitry are configured to operate in parallel.
(3) The apparatus of clause (2), wherein in the given iteration:
   the index determination circuitry is configured to determine the index by counting a number of leading zeros or a number of trailing zeros; and
   the preparation circuitry is configured to update the input bitmap, based on the isolation of the set bit, to remove the set bit from the input bitmap for the determining of the further index of the input bitmap by the index determination circuitry.
(4) The apparatus of clause (3), wherein the preparation circuitry is configured to obtain a reversed bitmap representative of a reverse of the input bitmap; and
   the preparation circuitry is configured to generate the isolation of the set bit by performing a bitwise AND operation between the reversed bitmap and a two's complement negation of the reversed bitmap.
(5) The apparatus of clause (4), wherein
   the preparation circuitry is configured to remove the set bit from the reversed bitmap by performing a bitwise XOR operation between the isolation of the set bit and the reversed bitmap.
(6) The apparatus of clause (4) or clause (5), wherein:
   the preparation circuitry is configured to generate the reversed bitmap;
   in a case where the given iteration is a first iteration, the index determination circuitry is configured to determine the index by counting the number of leading zeros; and
   in a case where the given iteration is after the first iteration, the index determination circuitry is configured to determine the index by counting the number of trailing zeros.
(7) The apparatus of clause (4) or clause (5), wherein
   the processing circuitry is configured to generate the reversed bitmap prior to a first iteration; and
   the index determination circuitry is configured to determine the index by counting the number of trailing zeros.
(8) The apparatus of any of clauses (3) to (7), wherein the index determination circuitry is configured to generate a completion signal in response to determining that the index is out-of-range.
(9) The apparatus of any of clauses (2) to (8), wherein:
   the processing circuitry comprises a variable latency unit comprising the index determination circuitry and the preparation circuitry, wherein
   the variable latency unit is configured to generate the index vector in a data-dependent number of iterations.
(10) The apparatus of any of clauses (2) to (8), wherein
   in response to the bitmap-index conversion instruction, the decoding circuitry is configured to generate control signals to control the processing circuitry to perform a predetermined number of iterations.
(11) The apparatus of clause (10), wherein
   in response to completing the predetermined number of iterations and determining that the input bitmap contains at least one index that has not yet been determined by the index determination circuitry, the processing circuitry is configured to repeat the predetermined number of iterations.
(12) The apparatus of clause (10), wherein
   in response to completing the predetermined number of iterations and determining that the input bitmap contains at least one index that has not yet been determined by the index determination circuitry, the processing circuitry is configured to perform a bitwise shift operation on the input bitmap based on a most-recently determined index to generate a shifted bitmap; and
   the processing circuitry is configured to repeat the predetermined number of iterations using the shifted bitmap in place of the input bitmap.
(13) The apparatus of clause (12), wherein in a case where the input bitmap is the shifted bitmap, the index determination circuitry is configured to increment the index by a value of the most-recently determined index prior to storing the index in the corresponding element of the index vector.
(14) The apparatus of clause (10), wherein the predetermined number of iterations is equal to a number of elements in the vector index.
(15) The apparatus of clause (10), wherein the predetermined number of iterations is equal to a number of count-leading-zeros operations that the processing circuitry is capable of performing in one cycle.
(16) The apparatus of clause (10), wherein the predetermined number of iterations is equal to a number of count-leading-zeros operations that the processing circuitry is capable of performing in one execution time-step.
(17) an Apparatus Comprising:
   processing circuitry; and
   decoding circuitry configured to decode instructions and generate control signals for controlling the processing circuitry, wherein
   in response to an index-bitmap conversion instruction indicating an index vector comprising a plurality of indices, the decoding circuitry is configured to generate control signals to control the processing circuitry to generate a plurality of partial bitmaps, each partial bitmap comprising a set bit corresponding to a respective one of the plurality of indices, and to combine the plurality of partial bitmaps to generate an output bitmap comprising set bits at each of the plurality of indices.
(18) The apparatus of clause (17), wherein the processing circuitry is configured to combine the plurality of partial bitmaps in parallel.
(19) The apparatus of clause (17) or clause (18), wherein the processing circuitry is configured to combine the plurality of partial bitmaps in a bitwise OR operation.
(20) The apparatus of any of clauses (17) to (19), wherein
   the index-bitmap conversion instruction indicates a bitmap size; and
   the processing circuitry is configured to combine the plurality of partial bitmaps with an input bitmap of the bitmap size.
(21) A system comprising:
   the apparatus of any preceding clause, implemented in at least one packaged chip;
   at least one system component; and
   a board,
wherein the at least one packaged chip and the at least one system component are assembled on the board.
(22) A chip-containing product comprising the system of clause (21), wherein the system is assembled on a further board with at least one other product component.
(23) A method comprising:
   decoding a bitmap-index conversion instruction indicating an input bitmap and generating control signals to control processing circuitry to perform one or more iterations to generate an index vector comprising a plurality of elements indicative of a plurality of indices of set bits in the input bitmap.
(24) A non-transitory computer-readable medium storing computer-readable code for fabrication of an apparatus comprising:
   processing circuitry; and
   decoding circuitry configured to decode instructions and generate control signals for controlling the processing circuitry, wherein
   in response to a bitmap-index conversion instruction indicating an input bitmap, the decoding circuitry is configured to generate control signals to control the processing circuitry to perform one or more iterations to generate an index vector comprising a plurality of elements indicative of a plurality of indices of set bits in the input bitmap.
(25) A computer program for controlling a host data processing apparatus to provide an instruction execution environment comprising:
   processing program logic; and
   decoding program logic configured to decode instructions and generate control signals for controlling the processing program logic, wherein
   in response to a bitmap-index conversion instruction indicating an input bitmap, the decoding program logic is configured to generate control signals to control the processing program logic to perform one or more iterations to generate an index vector comprising a plurality of elements indicative of one or more indices of set bits in the input bitmap.
(26) A method comprising:
   decoding an index-bitmap conversion instruction indicating an index vector comprising a plurality of indices and generating control signals to control processing circuitry to generate a plurality of partial bitmaps, each partial bitmap comprising a set bit corresponding to a respective one of the plurality of indices, and to combine the plurality of partial bitmaps to generate an output bitmap comprising set bits at each of the plurality of indices.
(27) A non-transitory computer-readable medium storing computer-readable code for fabrication of an apparatus comprising:
   processing circuitry; and
   decoding circuitry configured to decode instructions and generate control signals for controlling processing circuitry, wherein
   in response to an index-bitmap conversion instruction indicating an index vector comprising a plurality of indices, the decoding circuitry is configured to generate control signals to control the processing circuitry to generate a plurality of partial bitmaps, each partial bitmap comprising a set bit corresponding to a respective one of the plurality of indices, and to combine the plurality of partial bitmaps in parallel to generate an output bitmap comprising set bits at each of the plurality of indices.
(28) A computer program for controlling a host data processing apparatus to provide an instruction execution environment comprising:
   processing program logic; and
   decoding program logic configured to decode instructions and generate control signals for controlling the processing program logic, wherein
   in response to an index-bitmap conversion instruction indicating an index vector comprising a plurality of indices, the decoding program logic is configured to generate control signals to control the processing program logic to generate a plurality of partial bitmaps, each partial bitmap comprising a set bit corresponding to a respective one of the plurality of indices, and to combine the plurality of partial bitmaps in parallel to generate an output bitmap comprising set bits at each of the plurality of indices.

In brief overall summary, apparatuses, systems, methods, computer-readable media, and computer code are disclosed. An apparatus comprises processing circuitry and decoding circuitry to decode instructions and generate control signals for controlling the processing circuitry. In response to a bitmap-index conversion instruction indicating an input bitmap, the decoding circuitry generates control signals to control the processing circuitry to generate an index vector comprising a plurality of elements indicative of a plurality of indices of set bits in the input bitmap. In response to an index-bitmap conversion instruction indicating an index vector comprising a plurality of indices, the decoding circuitry generates control signals to control the processing circuitry to generate a plurality of partial bitmaps, each partial bitmap comprising a set bit corresponding to a respective one of the plurality of indices, and to combine the plurality of partial bitmaps to generate an output bitmap comprising set bits at each of the plurality of indices.

In the present application, the words “configured to...” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope of the invention as defined by the appended claims. For example, various combinations of the features of the dependent claims could be made with the features of the independent claims without departing from the scope of the present invention.

We claim:

1. An apparatus comprising:
processing circuitry; and
decoding circuitry configured to decode instructions and generate control signals for controlling the processing circuitry, wherein
in response to a bitmap-index conversion instruction indicating an input bitmap, the decoding circuitry is configured to generate control signals to control the processing circuitry to perform one or more iterations to generate an index vector comprising a plurality of elements indicative of a plurality of indices of set bits in the input bitmap.

2. The apparatus of claim 1, wherein:
the processing circuitry comprises index determination circuitry and preparation circuitry, wherein in a given iteration:
the index determination circuitry is configured to determine an index of a set bit in the input bitmap and store the index in a corresponding element of the index vector; and
the preparation circuitry is configured to generate an isolation of the set bit from the input bitmap, wherein the isolation is to be used in a subsequent iteration for determination of a further index of the input bitmap by the index determination circuitry,
wherein the index determination circuitry and the preparation circuitry are configured to operate in parallel.

3. The apparatus of claim 2, wherein in the given iteration:
the index determination circuitry is configured to determine the index by counting a number of leading zeros or a number of trailing zeros; and
the preparation circuitry is configured to update the input bitmap, based on the isolation of the set bit, to remove the set bit from the input bitmap for the determining of the further index of the input bitmap by the index determination circuitry.

4. The apparatus of claim 3, wherein the preparation circuitry is configured to obtain a reversed bitmap representative of a reverse of the input bitmap; and
the preparation circuitry is configured to generate the isolation of the set bit by performing a bitwise AND operation between the reversed bitmap and a two's complement negation of the reversed bitmap.

5. The apparatus of claim 2, wherein
the preparation circuitry is configured to remove the set bit from the reversed bitmap by performing a bitwise XOR operation between the isolation of the set bit and the reversed bitmap.

6. The apparatus of claim 4, wherein:
the preparation circuitry is configured to generate the reversed bitmap;
in a case where the given iteration is a first iteration, the index determination circuitry is configured to determine the index by counting the number of leading zeros; and
in a case where the given iteration is after the first iteration, the index determination circuitry is configured to determine the index by counting the number of trailing zeros.

7. The apparatus of claim 4, wherein
the processing circuitry is configured to generate the reversed bitmap prior to a first iteration; and
the index determination circuitry is configured to determine the index by counting the number of trailing zeros.

8. The apparatus of claim 3, wherein the index determination circuitry is configured to generate a completion signal in response to determining that the index is out-of-range.

9. The apparatus of claim 2, wherein:
the processing circuitry comprises a variable latency unit comprising the index determination circuitry and the preparation circuitry, wherein
the variable latency unit is configured to generate the index vector in a data-dependent number of iterations.

10. The apparatus of claim 2, wherein
in response to the bitmap-index conversion instruction, the decoding circuitry is configured to generate control signals to control the processing circuitry to perform a predetermined number of iterations.

11. The apparatus of claim 10, wherein
in response to completing the predetermined number of iterations and determining that the input bitmap contains at least one index that has not yet been determined by the index determination circuitry, the processing circuitry is configured to repeat the predetermined number of iterations.

12. The apparatus of claim 10, wherein
in response to completing the predetermined number of iterations and determining that the input bitmap contains at least one index that has not yet been determined by the index determination circuitry, the processing circuitry is configured to perform a bitwise shift operation on the input bitmap based on a most-recently determined index to generate a shifted bitmap; and
the processing circuitry is configured to repeat the predetermined number of iterations using the shifted bitmap in place of the input bitmap,
wherein in a case where the input bitmap is the shifted bitmap, the index determination circuitry is configured to increment the index by a value of the most-recently determined index prior to storing the index in the corresponding element of the index vector.

13. The apparatus of claim 10, wherein the predetermined number of iterations is equal to one of:
a number of count-leading-zeros operations that the processing circuitry is capable of performing in one execution time-step;
a number of elements in the vector index; or
a number of count-leading-zeros operations that the processing circuitry is capable of performing in one cycle.

14. An apparatus comprising:
processing circuitry; and
decoding circuitry configured to decode instructions and generate control signals for controlling the processing circuitry, wherein
in response to an index-bitmap conversion instruction indicating an index vector comprising a plurality of indices, the decoding circuitry is configured to generate control signals to control the processing circuitry to generate a plurality of partial bitmaps, each partial bitmap comprising a set bit corresponding to a respective one of the plurality of indices, and to combine the plurality of partial bitmaps to generate an output bitmap comprising set bits at each of the plurality of indices.

15. The apparatus of claim 14, wherein the processing circuitry is configured to combine the plurality of partial bitmaps in a bitwise OR operation.

16. The apparatus of claim 14, wherein
the index-bitmap conversion instruction indicates a bitmap size; and
the processing circuitry is configured to combine the plurality of partial bitmaps with an input bitmap of the bitmap size.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17, wherein the system is assembled on a further board with at least one other product component.

19. A non-transitory computer-readable medium storing computer-readable code for fabrication of an apparatus comprising:
processing circuitry; and
decoding circuitry configured to decode instructions and generate control signals for controlling the processing circuitry, wherein in response to a bitmap-index conversion instruction indicating an input bitmap, the decoding circuitry is configured to generate control signals to control the processing circuitry to perform one or more iterations to generate an index vector comprising a plurality of elements indicative of a plurality of indices of set bits in the input bitmap.

20. A computer program for controlling a host data processing apparatus to provide an instruction execution environment comprising:
processing program logic; and
decoding program logic configured to decode instructions and generate control signals for controlling the processing program logic, wherein in response to a bitmap-index conversion instruction indicating an input bitmap, the decoding program logic is configured to generate control signals to control the processing program logic to perform one or more iterations to generate an index vector comprising a plurality of elements indicative of one or more indices of set bits in the input bitmap.
